(19) United States
(12) Patent Application Publication
(10) Pub. No.: US 2013/0166885 A1
(43) Pub. Date: Jun. 27, 2013

(54) METHOD AND APPARATUS FOR ON-CHIP TEMPERATURE

(71) Applicants: Karthik Ramani, Sunnyvale, CA (US); Stephen Presant, San Jose, CA (US); John Brothers, Calistoga, CA (US)

(72) Inventors: Karthik Ramani, Sunnyvale, CA (US); Stephen Presant, San Jose, CA (US); John Brothers, Calistoga, CA (US)

(73) Assignee: ADVANCED MICRO DEVICES, INC., Sunnyvale, CA (US)

(21) Appl. No.: 13/531,013

(22) Filed: Jun. 22, 2012

Related U.S. Application Data
(60) Provisional application No. 61/580,490, filed on Dec. 27, 2011.

(51) Int. Cl. G01K 3/00; G06F 9/30

(52) U.S. Cl. 712/214; 374/101; 374/E03.001; 712/E09.016

(57) ABSTRACT

When an instruction is executed on an integrated circuit (IC), an activity level and temperature are measured. A relationship between the activity level and temperature is determined, to estimate the temperature from the activity level. The activity level is monitored and is input to a scheduler, which estimates the IC temperature based on the activity level. The scheduler distributes work taking into account the temperature of various IC regions and may include distributing work to the IC region that has a lowest estimated temperature or relatively lower estimated temperature (e.g., lower than the average IC or IC region temperature). When the utilization level of one or more IC regions is high, the scheduler is configured to reduce the clock speed or the voltage of the one or more IC regions, or flag the regions as being unavailable for additional workload.

### FIELD OF INVENTION

This application relates generally to techniques for measuring on-chip temperature and applications thereof.

### BACKGROUND

In modern complex processors, unexpected thermal events such as localized hotspots can occur when a small area of the processor is continuously active when executing a given set of instructions. The resulting power density increases the temperature of the chip and causes a hotspot to form in the processor. These hotspots may cause spatial thermal gradients that affect the performance and lifetime of the chip.

Most modern processor designs use temperature-based estimates at a course grain resolution to determine how much power is being dissipated through heat. Current mechanisms for estimating and mitigating excessive power loss through heat dissipation are reactive measures and are predominantly sensor-based. Analog sensors, such as diodes, are placed on the die and their output is used as a proxy for on-chip temperature.

These measurements, however, tend to vary based on the ambient temperature. For example, an identical chip with identical sensors and based on identical input may give different temperature estimates in a cold climate than it would in a warm climate. As a result, the response mechanisms utilized to mitigate power loss will be different depending on the geographic location of the chip. Therefore, the overall performance of an identical chip processing identical data will differ depending on the geographic location of the chip.

Other techniques employed in the past convert power dissipation and prior temperature to temperature estimates. Power estimates may be made based on measures of activity. The resulting power estimates may then be converted to temperature with knowledge of the prior temperature in a given region and modeling of heat dissipation laterally in the silicon and vertically through the thermal interface material, package lid, heat sink, and so on. These techniques estimate the temperature at a coarse resolution and are not suitable for predicting the development of hotspots.

Another existing method for determining on-die temperature is through thermal sensors built into the silicon. While these techniques may be used to implement thermal management systems into hardware, they cannot be applied to modeling thermal events for product development and planning. Also, when implemented in hardware, the accuracy of the thermal sensors is adversely affected by process variations and may be difficult to calibrate.

Current scheduling techniques in modern processors typically focus on processing workloads as fast as possible without any consideration of on-die power density or temperature. Issues involving power management and efficiency are expected to increase in quantity and complexity. Power density (i.e., the amount of power over a set area of the die) and the amount of power of a localized component are expected to be more diverse in the future.

Therefore, it is desirable to develop more accurate methods of predicting on-die temperature and to incorporate accurate predictions into the scheduling of work across the die.

### SUMMARY OF EMBODIMENTS

A method and apparatus are disclosed for estimating temperature and scheduling workload on an integrated circuit (IC). When an instruction is executed on the IC, an activity level and temperature are measured. A relationship between the activity level and the temperature is determined, allowing the temperature to be estimated from the activity level. The activity level of the IC is monitored and is input to a scheduler, which estimates the temperature of the IC based on the activity level. The scheduler distributes work taking into account the temperature of various regions of the IC and may include distributing work to the region of the IC that has the lowest estimated temperature or relatively lower estimated temperature (e.g., lower than the average IC or IC region temperature). When the utilization level of one or more regions of the IC is high, the scheduler is configured to reduce the clock speed or reduce the voltage of the one or more regions of the IC, or flag the one or more regions as being unavailable for additional workload.

A method of measuring estimated temperature on an integrated circuit (IC) having a plurality of regions includes executing an instruction on the IC; measuring an activity level and a temperature of each of the plurality of regions; and determining the relationship between the measured temperature and the activity level.

An integrated circuit includes a plurality of regions selectable for processing activity, a plurality of activity monitors, and a scheduler. The plurality of activity monitors are configured to monitor an activity level of each of the plurality of regions, wherein the activity level is proportional to an estimated temperature. The scheduler is configured to distribute instructions to the plurality of regions, wherein the scheduler distributes instructions to regions based on the activity level.

An integrated circuit includes a scheduler configured to distribute instructions to a plurality of regions, wherein the scheduler distributes instructions to a region based on a temperature of each of the plurality of regions.

A method of scheduling instructions in an IC includes monitoring an activity level of a plurality of regions on the IC and computing an estimated temperature for each of the plurality of regions based on the activity level.

A non-transitory computer-readable storage medium storing a set of instructions for execution by one or more processors to facilitate manufacture of an integrated circuit device, the integrated circuit device including a plurality of processing units, a plurality of activity monitors, a scheduler, and a logic circuit. The plurality of activity monitors are configured to monitor an activity level of each of the plurality of processing units, wherein the activity level is proportional to an estimated temperature. The scheduler is configured to distribute instructions to the plurality of processing units, wherein the scheduler distributes instructions to a processing unit with a lowest estimated temperature based on the activity level. The logic circuit is configured to determine a utilization level of at least one of the plurality of processing units.

### BRIEF DESCRIPTION OF THE DRAWINGS

A more detailed understanding may be had from the following description, given by way of example in conjunction with the accompanying drawings, wherein:

FIG. 1 is a block diagram of an example device in which one or more disclosed embodiments may be implemented;

FIG. 2 shows a die divided into M×N regions;

FIG. 3 is a flowchart showing a method of determining the relationship between temperature and activity level of the die;

FIG. 4 is a flowchart showing a method of generating a temperature and/or current map based on the activity level of the die;

FIG. 5 is a flowchart of a method of scheduling instructions based on an activity level; and

FIG. 6 is a flowchart of a second method of scheduling instructions based on an activity level.

### DETAILED DESCRIPTION OF THE EMBODIMENTS

Accurate on-die temperature estimation at high spatial resolution is important for achieving better performance, performance per watt of power, power management, energy efficiency, and reliability. Accurate temperature estimation allows for identification and mitigation of localized hotspots, thermal gradients, and transient thermal variations. Accurate temperature estimation may also be used to reduce system cost by reducing package and cooling solution costs. In addition, accurate temperature estimation may improve the long-term product reliability by minimizing electro-migration, a function of current and temperature, as well as package and thermal interface material (TIM) reliability.

In addition, it is often desirable to obtain a theoretical maximum temperature for all devices of a given product line. This theoretical maximum temperature represents a worst case scenario for a particular device, as determined by worst case process variations. The theoretical maximum temperature may also represent a worst case environmental scenario for the device. This theoretical maximum temperature provides the outer bounds of expected scenarios. Thermal management is performed with this input to obtain deterministic worst case behavior across a whole line of products, which is often an important market requirement.

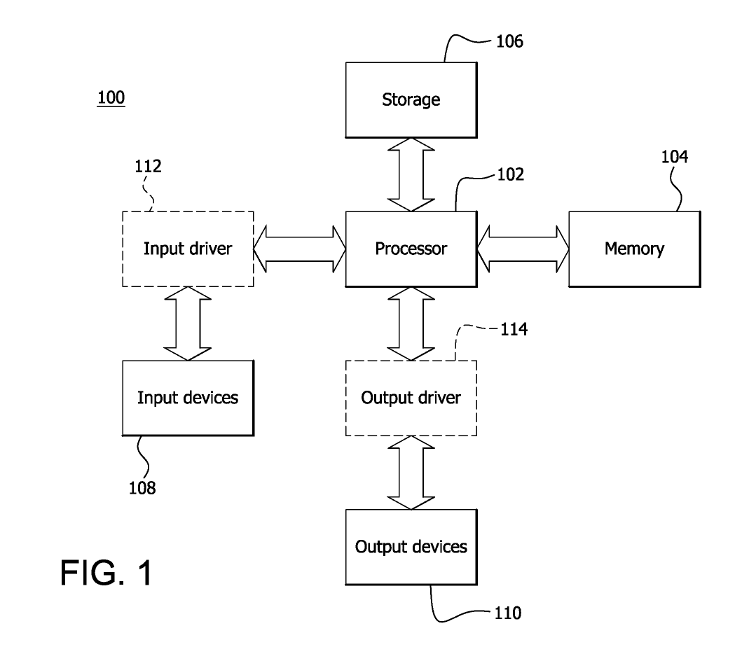

FIG. 1 is a block diagram of an example device 100 in which one or more disclosed embodiments may be implemented. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 may also optionally include an input driver 112 and an output driver 114. It is understood that the device 100 may include additional components not shown in FIG. 1.

The processor 102 may include a central processing unit (CPU), a graphics processing unit (GPU), a CPU and GPU located on the same die, or one or more processor cores, wherein each processor core may be a CPU or a GPU. The memory 104 may be located on the same die as the processor 102, or may be located separately from the processor 102. The memory 104 may include a volatile or non-volatile memory, for example, random access memory (RAM), dynamic RAM, or a cache.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner is the input driver 112 and the output driver 114 are not present.

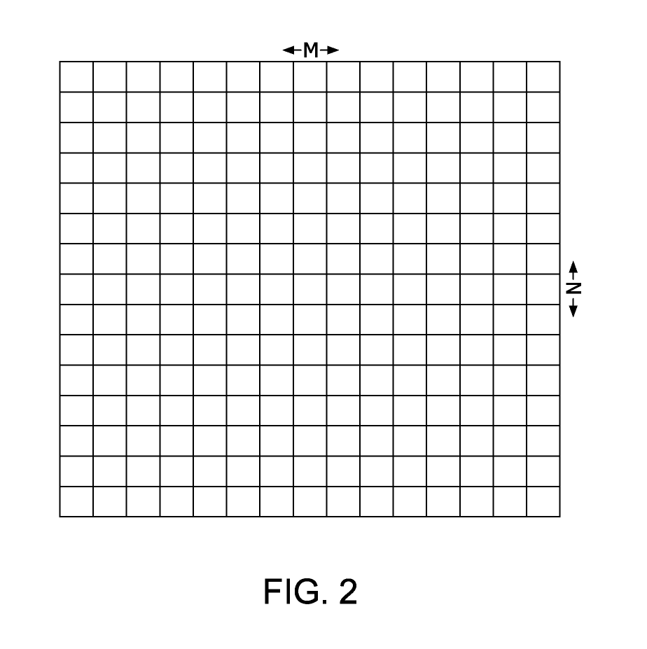

A die may be subdivided into M×N regions as illustrated in FIG. 2. This allows for substantial flexibility in the resolution and accuracy of temperature and current estimates based on the disclosed methods. In a simple example, a die that contains four processing units may be divided into 2×2 logical regions, such that each region contains one processing unit. The described embodiments are not limited by size, and any size die with any number and type of components may be subdivided into M×N regions to achieve a desired granular resolution from a temperature estimation model. There are no restrictions placed on the aspect ratio of the regions. In a simple case, each region may be a functional block with a known area on the die.

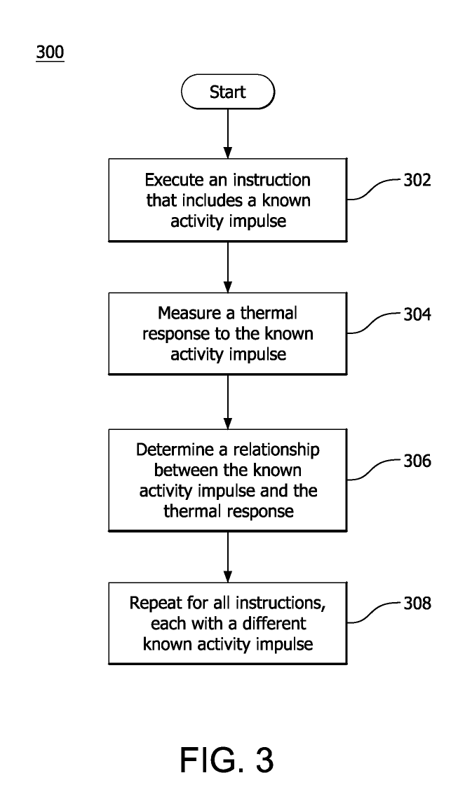

In an embodiment shown in FIG. 3, a model of device thermal behavior is developed by process 300. An instruction that includes a known activity impulse is executed by a block on the die (step 302). On-die thermal responses to the known activity impulses are measured in the various logic blocks spatially distributed on the die (step 304). For a given spatial resolution, this may be achieved by obtaining thermal images for known application benchmarks and activity impulses using an infra-red camera. Changes in on-die activity level lead to changes in on-die temperature which may be measured directly. For example, temperature (T) is a function of the change in block activity (A) and a prior temperature. This may be written as a mathematical equation for a given unit on the processor:

T=f(A, Tₚ) (Equation 1)

Where T=estimated temperature, A=block activity, and Tₚ=prior temperature.

The relationship between the activity levels and the measured temperature is determined using Equation 1 (step 306). The process is repeated for each of a known set of impulses corresponding to various typical workloads that may be expected (step 308). A set of linear equations may be solved to map the activity of a block to the temperature profile. The solver used may be a simple solver, such as one offered in a commercial spreadsheet package.

The solution to the set of linear equations is a set of thermal coefficients that maps the activity, as measured by performance counters (i.e., activity monitors), to an estimated temperature of the block. By using the thermal coefficients as multipliers to unit activity, the on-die temperature for a given input generating a given on-die activity level may be predicted.

In practice, the activity of adjacent blocks also adds to or subtracts from the temperature of the block due to lateral heat transfer. Heat is also eliminated through the fan-sink. Hence, Equation 1 may be modified as follows.

T=f(A, A_{adj}, Aₛᵢₙₖ, Tₚ) (Equation 2)

Where T=estimated temperature, A=block activity, A_{adj}=adjacent block activity, Aₛᵢₙₖ=heat sink activity, and Tₚ=prior temperature.

Equation 2 may be used to calculate the relationship in step 306 of FIG. 3 as described above. Equation 2 allows for a more sophisticated temperature estimation model by taking into account the activity of adjacent blocks and heat sinks. An adjacent block may be hotter or cooler than the block that is being measured. Depending on the ambient temperature and the fabrication process, a fraction of the heat is dissipated in a lateral direction and the rest of the heat is dissipated in a vertical direction. Hence, the temperature of the block being measured is also dependent on the heat dissipated by its neighboring blocks.

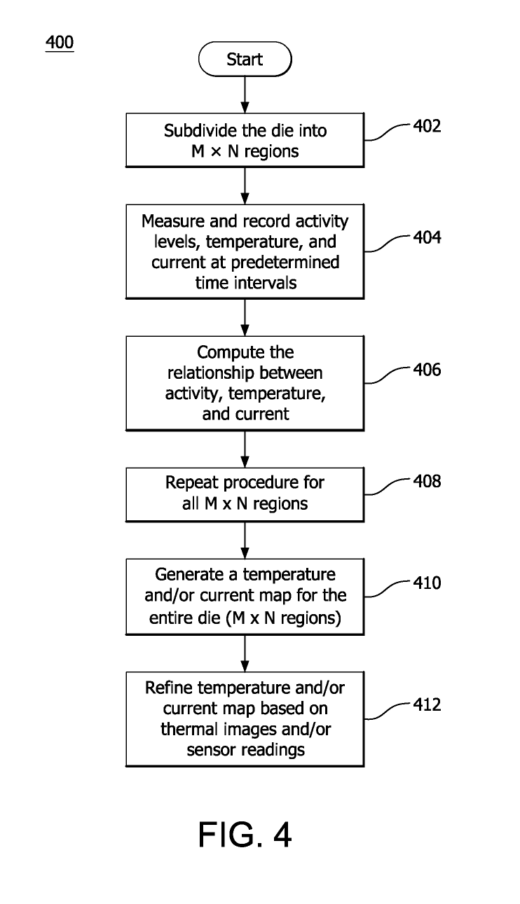

FIG. 4 is a flowchart showing a method 400 of generating a temperature and/or current map based on the activity level of the die. The die is subdivided into M×N regions for which temperature and current may be estimated (step 402), where M and N are integers, as illustrated in FIG. 2. The die will be subjected to different workloads that generate varying activity levels. The activity level (A), the actual temperature (T), and/or the current (I) may be measured and recorded at predetermined time intervals (step 404). The temperature may be measured through sensors or thermal imaging. Similarly, the current may be measured through on-die current sensors. A solver computes the relationship between the activity level and the temperature and between the activity level and the current (step 406). This procedure is repeated for all M×N regions on the die (step 408).

Based on the relationship between the activity level, the temperature, and the current, a temperature and/or current map may be generated for the entire die (step 410). As discussed above, the number of regions may be selected to provide a desired granular resolution for the temperature estimates. The method may be refined through correlation against thermal images or sensor readings (step 412).

Temperature estimation maps are used for thermal analysis and thermal management of hot spots and thermal gradients on the die. The temperature data may also be used for package and cooling design, and as an input to logic timing analysis. For reliability studies, the current plus the temperature data is used to determine FIT rates due to electro-migration. The mean time to failure (MTTF) of the on-chip interconnects is based on Black's equation and is directly dependent on the current density in the block and is exponentially dependent on the temperature. Determining the MTTF may be useful in large data center environments to track the availability of individual nodes.

Another embodiment includes pro-active instruction and data scheduling procedures to maintain uniform power density in both time and space in all units on the die. As the on-die activity level rises, so does the on-die temperature. As the temperature increases, the amount of power that is dissipated through heat increases as well as reducing system performance and product lifetime.

Unlike reactive mechanisms that impact system performance, such as frequency throttling, the disclosed scheduling procedures distribute work in a way to minimize hotspots. Reduced hot spots and thermal cycling allows for lower cost cooling solutions and better chip reliability. In addition, by minimizing the thermal gradients and maintaining a lower die temperature, the impacts of temperature may be minimized and power leakage may be reduced, contributing to better performance and power efficiency.

In the following set of exemplary embodiments, a die may include multiple processing units. When one processing unit begins to operate at a higher power density, work may be scheduled to another processing unit such that all processing units are being utilized at an optimum level, yet are not overworked so as to generate localized hotspots.

When all processing units are utilized at maximum utilization, performance may be negatively affected. By taking temperature estimates into account when scheduling work across the multiple processing units, the on-die temperatures may be kept at a lower level than with using current schedulers. Due to the direct relationship between temperature and power leakage, the die will dissipate less power. Thus, it is possible to extract more performance out of the same system by carefully managing the temperature.

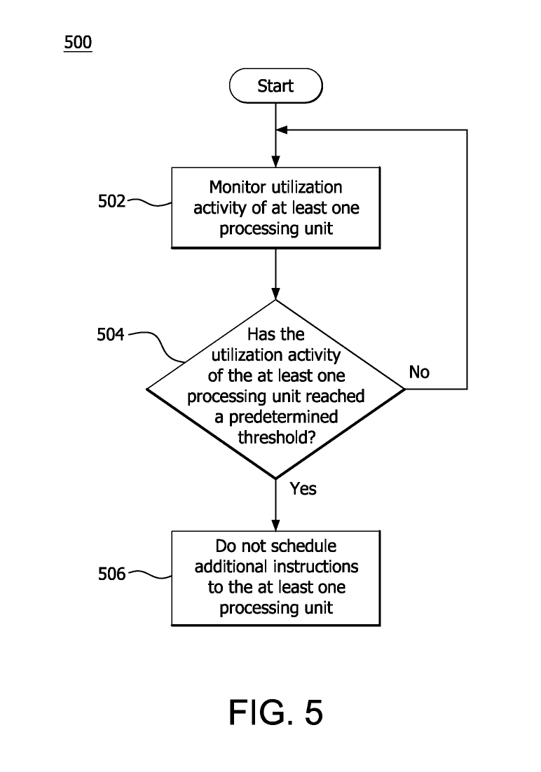

FIG. 5 is a flowchart of a method 500 of scheduling instructions based on an activity level. In the method 500, the scheduler detects a temperature hotspot forming at one processing unit and schedules future work for other processing units once the temperature of the hotspot reaches or exceeds a predetermined threshold. The activity level of a processing unit is monitored (step 502). The scheduler makes a logical determination of whether the activity has reached a particular threshold (step 504). If the activity has reached or surpassed the threshold, the scheduler flags the processing unit as unavailable for additional work scheduling for a predetermined amount of time (step 506). If the scheduler determines that the activity level of the processing unit has not reached the threshold, then the method 500 repeats.

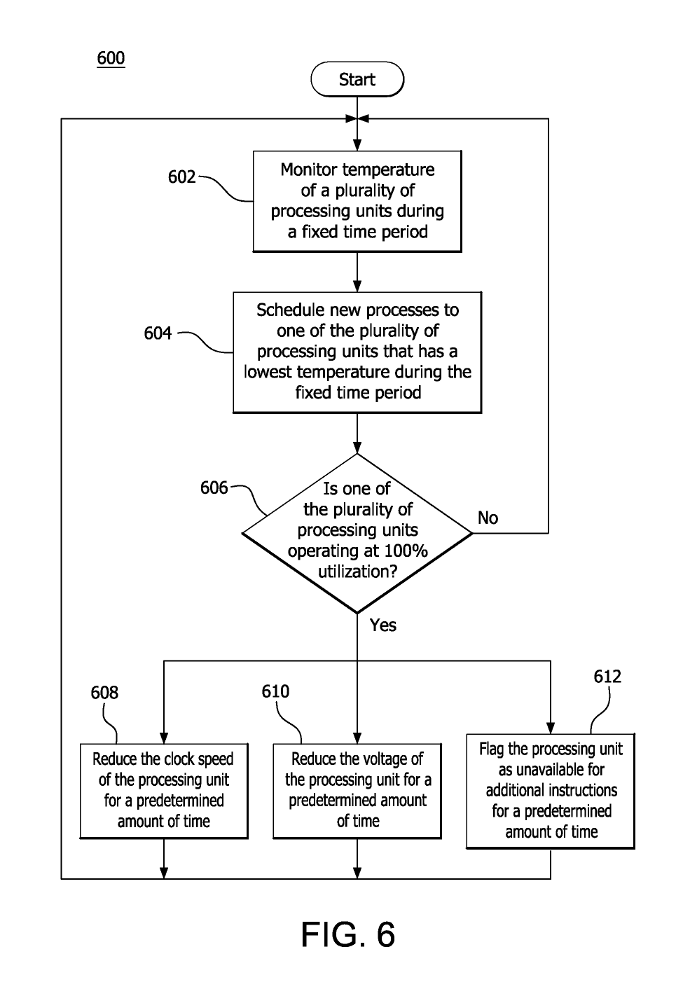

FIG. 6 is a flowchart of a method 600 of scheduling instructions based on an activity level. In the method 600, the scheduling decisions are made in a more proactive manner. The temperature levels of a plurality of processing units are monitored during a fixed time period (step 602). The scheduler distributes work to one of the plurality of processing units that exhibits the lowest temperature during the fixed time period (step 604) or to units that have lower (e.g., lower than average IC) temperatures during the fixed time period.

As previously described, the scheduler is actively distributing work to the processors with lower temperatures (e.g., the lowest temperature). Because the activity level is directly related to the temperature level, it is likely that a processing unit operating at or near full utilization is running at a high temperature. Since the scheduler is already distributing work to the processing units that have lower temperatures, it is likely that all the processing units on the die are operating at or near full utilization and are at a high temperature. In this situation, an additional mechanism is required to actively reduce the on-die temperature. To accomplish this, the scheduler also tracks the overall temperature of the entire die.

A determination is made whether one of the processing units on the die is at or near full utilization (step 606). If the processing unit is operating at or near full utilization, one of three actions may result. A first option is that the scheduler reduces the clock speed of the processing unit for a predetermined amount of time (step 608). This has the effect of reducing the speed at which work is processed by that unit, thereby cooling the unit. A second option is that the scheduler reduces the voltage of the processing unit for a predetermined amount of time (step 610). This has the effect of reducing the amount of power consumed by the processor, thus allowing the unit to cool. A third option is that the scheduler flags the processing unit as unavailable for additional instructions for a predetermined amount of time (step 612). This has the effect of preventing work from being scheduled to the processing unit, thus allowing the unit to cool. Once the scheduler chooses one or more of these actions, the procedure restarts.

Such a scheme creates an automatic regulatory scheduling system that reduces the rate at which on-die temperature increases. For example, if unit 5 has the lowest temperature, then the next instruction is scheduled for unit 5. When the activity on unit 5 increases such that it is operating at a higher power relative to the other units, unit 5 will automatically not receive any more work. This scheme, thus, regulates temperature across the entire die by identifying the processing unit with the lowest temperature and scheduling data to it.

As an example, all units on a die are operating at a high utilization, and the temperature of the die has reached 110° C. The power leakage is about 30% higher than if the die was operating at 90° C. Current technology only allows for throttling the clock speed and the voltage of the die as a whole, which causes loss of performance. The scheme described above offers a more proactive mechanism for accomplishing the same result, but changes the clock speed or the voltage at locations closer to the processing units. Thus, the time in which the processing is slowed down is lower.

Although features and elements are described above in particular combinations, each feature or element may be used alone without the other features and elements or in various combinations with or without other features and elements. The apparatus described herein may be manufactured by using a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Embodiments of the present invention may be represented as instructions and data stored in a non-transitory computer-readable storage medium. For example, aspects of the present invention may be implemented using Verilog, which is a hardware description language (HDL). When processed, Verilog data instructions may generate other intermediary data (e.g., netlists, GDS data, or the like) that may be used to perform a manufacturing process implemented in a semiconductor fabrication facility. The manufacturing process may be adapted to manufacture semiconductor devices (e.g., processors) that embody various aspects of the present invention.

Suitable processors include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

Processors may be any one of a variety of processors such as a central processing unit (CPU) or a graphics processing unit (GPU). For instance, they may be x86 microprocessors that implement x86 64-bit instruction set architecture and are used in desktops, laptops, servers, and superscalar computers, or they may be Advanced RISC (Reduced Instruction Set Computer) Machines (ARM) processors that are used in mobile phones or digital media players. Other embodiments of the processors are contemplated, such as Digital Signal Processors (DSP) that are particularly useful in the processing and implementation of algorithms related to digital signals, such as voice data and communication signals, and microcontrollers that are useful in consumer applications, such as printers and copy machines. Although the embodiment may include one processor for illustrative purposes, any other number of processors will be in-line with the described embodiments.

What is claimed is:

1. A method of measuring estimated temperature on an integrated circuit (IC) having a plurality of regions, the method comprising:
executing an instruction on the IC;
measuring an activity level and a temperature of each of the plurality of regions; and
determining the relationship between the measured temperature and the activity level.

2. The method of claim 1, further comprising:
generating a temperature map for the IC.

3. The method of claim 2, further comprising:
refining the temperature map by measuring a temperature and an activity level produced by different instructions.

4. The method of claim 1, further comprising:
measuring a current level for each of the plurality of regions; and
generating a current map for the IC.

5. The method of claim 4, further comprising:
predicting a mean time to failure of the IC based on the current map.

6. An integrated circuit (IC) comprising:
a plurality of regions selectable for processing activity;
a plurality of activity monitors configured to monitor an activity level of each of the plurality of regions, wherein the activity level is proportional to an estimated temperature; and
a scheduler configured to distribute instructions to each of the plurality of regions, wherein the scheduler distributes instructions to regions based on the activity level.

7. The IC of claim 6, further comprising:
a logic circuit configured to determine a utilization level of at least one of the plurality of regions.

8. The IC of claim 6, wherein the scheduler is further configured to reduce a clock speed of at least one of the plurality of regions if the determined utilization level is high.

9. The IC of claim 6, wherein the scheduler is further configured to reduce a voltage of at least one of the plurality of regions if the determined utilization level is high.

10. The IC of claim 6, wherein the scheduler is further configured to flag at least one of the plurality of regions as unavailable for additional instruction processing if the determined utilization level is high.

11. The IC of claim 6, wherein each of the plurality of regions includes a processing unit.

12. An integrated circuit (IC), comprising:
a scheduler configured to distribute instructions to a plurality of regions, wherein the scheduler distributes instructions to a region based on a temperature of each of the plurality of regions.

13. The IC of claim 12, wherein the scheduler is configured to distribute an instruction to a region capable of executing the instruction with a lowest temperature of those regions of the plurality of regions that are also capable of executing the instruction.

14. The IC of claim 12, wherein the scheduler is configured to distribute an instruction to a region capable of executing the instruction with a temperature lower than an average temperature of those regions of the plurality of regions that are also capable of executing the instruction.

15. A method of scheduling instructions in an integrated circuit (IC), the method comprising:
monitoring an activity level of a plurality of regions on the IC; and
computing an estimated temperature for each of the plurality of regions based on the activity level.

16. The method of claim 15, further comprising:
distributing instructions to a region with a lowest estimated temperature.

17. The method of claim 15, further comprising:
determining a utilization level of at least one of the plurality of regions.

18. The method of claim 15, further comprising:
reducing a clock speed of at least one of the plurality of regions if the utilization level is high.

19. The method of claim 15, further comprising:
reducing a voltage of at least one of the plurality of regions if the utilization level is high.

20. The method of claim 15, further comprising:
flagging at least one of the plurality of regions as unavailable for additional instruction processing if the utilization level is high.

21. The method of claim 15, wherein each of the plurality of regions includes a processing unit.

22. A non-transitory computer-readable storage medium storing a set of instructions for execution by one or more processors to facilitate manufacture of an integrated circuit device, the integrated circuit device comprising:
a plurality of processing units;
a plurality of activity monitors configured to monitor an activity level of each of the plurality of processing units, wherein the activity level is proportional to an estimated temperature;
a scheduler configured to distribute instructions to the plurality of processing units, wherein the scheduler distributes instructions to a processing unit with a lowest estimated temperature based on the activity level; and
a logic circuit configured to determine a utilization level of at least one of the plurality of processing units.

23. The non-transitory computer-readable medium of claim 22, wherein the instructions are hardware description language (HDL) instructions used for the manufacture of a device.
